(19) United States
(12) Patent Application Publication
(10) Pub. No.: US 2024/0301854 A1
(43) Pub. Date: Sep. 12, 2024

(54) WAVE DRIVEN ELECTRICAL GENERATOR

(71) Applicant: Blue Lotus Energy Corporation, Adair, OK (US)

(72) Inventor: ROWDY ROGER MALCHOW, II, Stillwater, OK (US)

(21) Appl. No.: 18/485,995

(22) Filed: Oct. 12, 2023

Related U.S. Application Data
(60) Provisional application No. 63/415,545, filed on Oct. 12, 2022.

(51) Int. Cl. F03B 13/18; F03B 13/22

(52) U.S. Cl. CPC F03B 13/1875; F03B 13/22

(57) ABSTRACT

The invention relates to a wave driven electrical generator having a single panel, or an array of panels that may be triangular in shape or may have another shape. A movable connection is provided between the panels to allow relative movement in two dimension or three dimensions. The movable connection may include at least one panel link has a length that is at least as long as the width of the panels to facilitate stacking of the panels for storage. One or multiple generators may be mounted on each panel and may be housed in a cavity where it is protected from damage and/or exposure to water. The area of coverage of a panel array includes open areas within the array of panels that define less than 20% of the area of coverage thereby facilitating the generation of maximum amount of power with a relatively small footprint.

### CROSS REFERENCE TO RELATED APPLICATIONS

This application claims the priority of U.S. Provisional Patent Application No. 63/415,545 titled “WAVE DRIVEN ELECTRICAL GENERATOR,” filed Oct. 12, 2022, the contents of which are hereby incorporated by reference.

### FIELD OF THE INVENTION

The invention relates to an electrical generator that produces power from the motion of waves. In particular, the invention relates to a buoyant panel or an array of buoyant panels for producing power from the motion of waves.

### BACKGROUND OF THE INVENTION

The development of renewable energy has become more of a global priority in recent years. Renewable energy includes sources such as sunlight, wind, the movement of water, and geothermal heat. In one aspect, renewable energy provides energy for electricity generation to a grid, for storage in batteries, or to provide power of electrically powered devices. One example of renewable energy is a wave driven electrical generator.

### SUMMARY OF THE INVENTION

A wave driven electrical generator of the invention includes multiple floating panels, such as triangularly shaped panels, that are joined together to form an interconnected sheet or array of panels. Each panel may carry multiple, e.g., three, cavities or channels in which magnetic members, e.g., spheres, cylinders, or other shapes, travel back and forth as the panel is rocked by waves. In one embodiment, the cavity or channel is surrounded by a coil wrapped stator, e.g., wrapped with copper wire, such that repeated back and forth travel of the magnetic member through the coil will produce electricity. In another embodiment, a coil wrapped cylinder travels back and forth over a magnet carrying rod as the panel is rocked by waves. Other generator configurations are possible.

The interconnected panels form a floating sheet or array on the surface of water. As waves pass under the floating sheet of interconnected panels, each panel is tilted back and forth, thereby providing motive force for the movable members in the generator. As can be appreciated, many interconnected panels, each tilting and oscillating in reaction to, e.g., ocean waves, can be used to produce electricity, which can be stored or delivered onshore via a single cable or by other methods.

Each panel is preferably sealed to facilitate flotation and to prevent water from entering the interior and from making contact with the coil or magnetic member.

Other embodiments are possible including the use of alternative panel shapes. In another embodiment, a floating battery may be provided to store the generated electricity rather than transmitting the electricity to shore.

In particular, the invention relates to a wave driven electrical generator having a single panel, or an array of panels that include a first buoyant panel having a first side, a second side and at least three perimeter sides, the perimeter sides having a height that defines a width of the first buoyant panel, said array of panels further including a second buoyant panel having a first side, a second side and at least three perimeter sides, the perimeter sides having a height that defines a width of the second buoyant panel.

The panels may be triangular in shape or may have another shape.

A movable connection is provided between the first buoyant panel and the second buoyant panel to allow relative movement of the panels in two dimension or three dimensions. The movable connection may include at least one panel link has a length that is at least as long as the width of the panels to facilitate stacking of the first buoyant panel and the second buoyant panel, e.g., for storage.

A generator is mounted on at least one of the first buoyant panel and the second buoyant panel. Multiple generators may be mounted on each panel of the array. Each generator may be housed in a cavity where it is protected from damage and may be protected from exposure to water. In one embodiment, e.g., an embodiment wherein the panel has a triangular shape, three cavities, each being elongate in shape and oriented with a first end proximate one of the corner regions and extending towards a center of the first buoyant panel such that a longitudinal axis of the cavity is normal to a side of the triangle shape opposite the corner region.

The array of panels define an area of coverage. The area of coverage includes open areas within the array of panels. The open areas define less than 20% of the area of coverage thereby facilitating the generation of maximum amount of power with a relatively small footprint.

### BRIEF DESCRIPTION OF THE DRAWINGS

FIG. 1 is a perspective view of a buoyant panel of the invention;

FIG. 2 is a plan view of the buoyant panel of FIG. 1;

FIG. 3 is a cross-sectional perspective view of the buoyant panel of FIG. 1 and an exploded view of cover embodiments;

FIG. 4A is a plan view of an example electrical generator of the invention;

FIG. 4B is a schematic view of an example electrical generator of the invention;

FIG. 5A is a plan view of an assembled array of buoyant panels;

FIG. 5B is a plan view of a second embodiment of an assembled array of buoyant panels showing electrical interconnectedness of generators on the panels;

FIG. 5C is an enlarged plan view of a portion of the assembled array having a schematic of power generating components and showing an alternative movable connection;

FIG. 5D is a schematic of power generating components of FIG. 5C;

FIG. 6 is a plan view of the assembled array of FIG. 5A shown partially stacked;

FIG. 7 is a plan view of the assembled array of FIG. 5A shown in a stacked configuration;

FIG. 8 is an elevation view of the assembled array of FIG. 5A shown in a stacked configuration;

FIG. 9 is a photograph of the assembled array of FIG. 5A shown floating in water;

FIG. 10 is a photograph of the assembled array of FIG. 5A shown floating in water;

FIG. 11 is a diagram showing a method to generate power utilizing a buoyant panel of the invention;

FIG. 12 is a diagram showing electrical components for a control system for generating and storing electricity generated by the buoyant panel of the invention;

FIG. 13 is a schematic of electrical components for storing electricity generated and stored by the wave powered generator of the invention;

FIG. 14 is a plan view of an alternate embodiment of a buoyant panel having a round shape;

FIG. 15 is a plan view of an alternate embodiment of a buoyant panel having a hexagonal shape;

FIG. 16 is a plan view of an alternate embodiment of a buoyant panel having a square shape;

FIG. 17 is a perspective view of the panel having a square shape of FIG. 16.

### DETAILED DESCRIPTION OF THE PREFERRED EMBODIMENTS

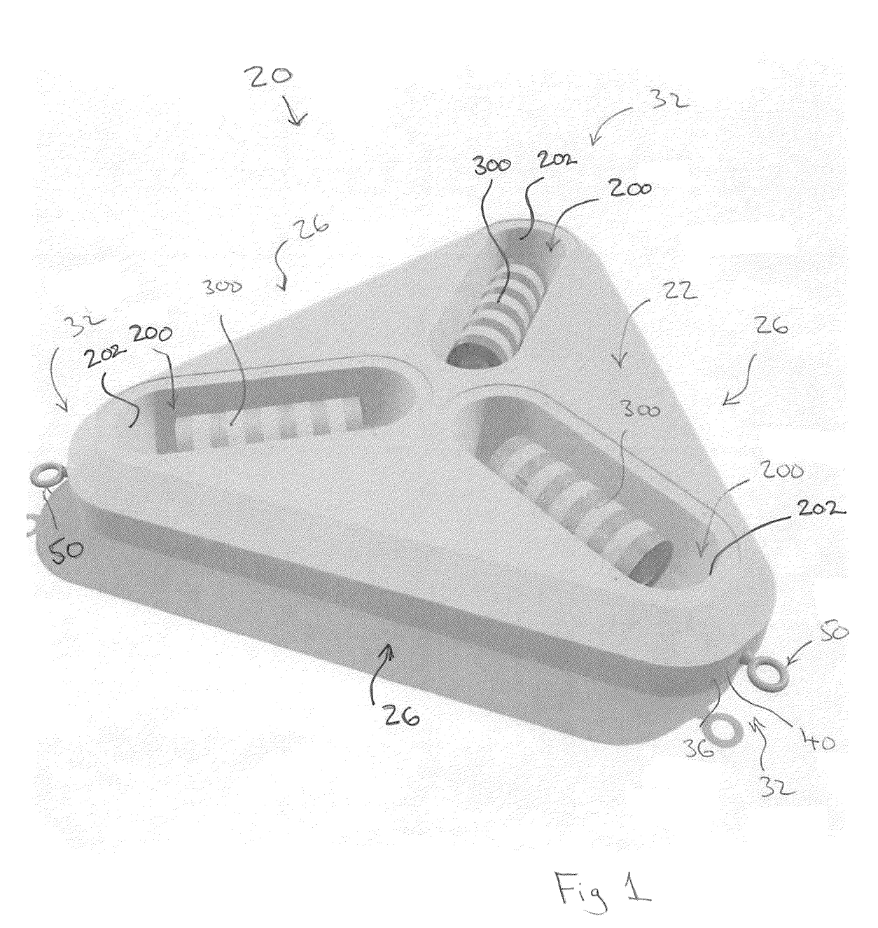

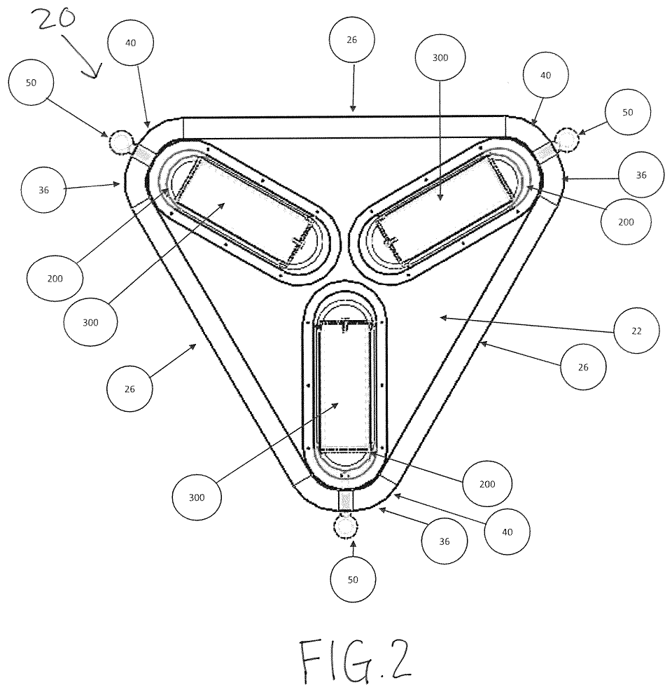

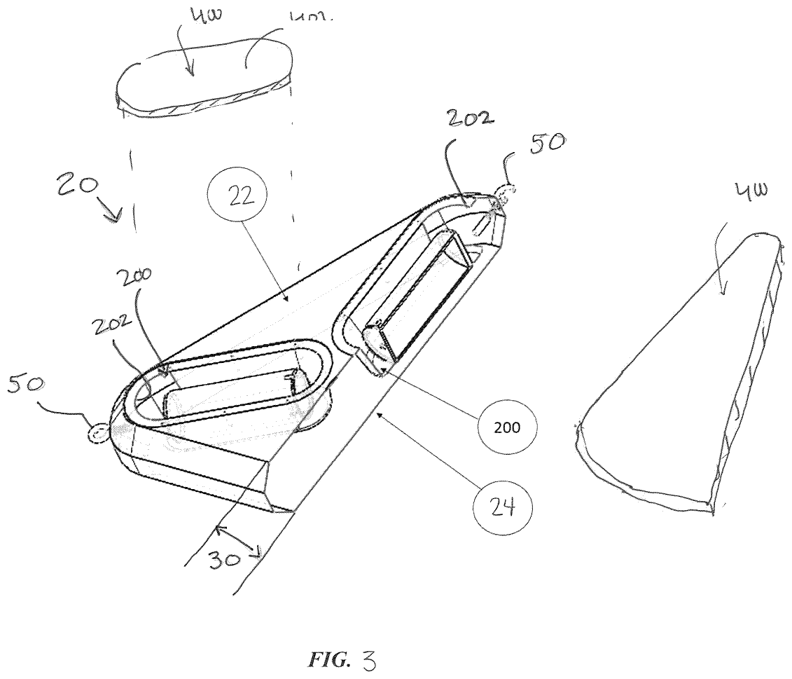

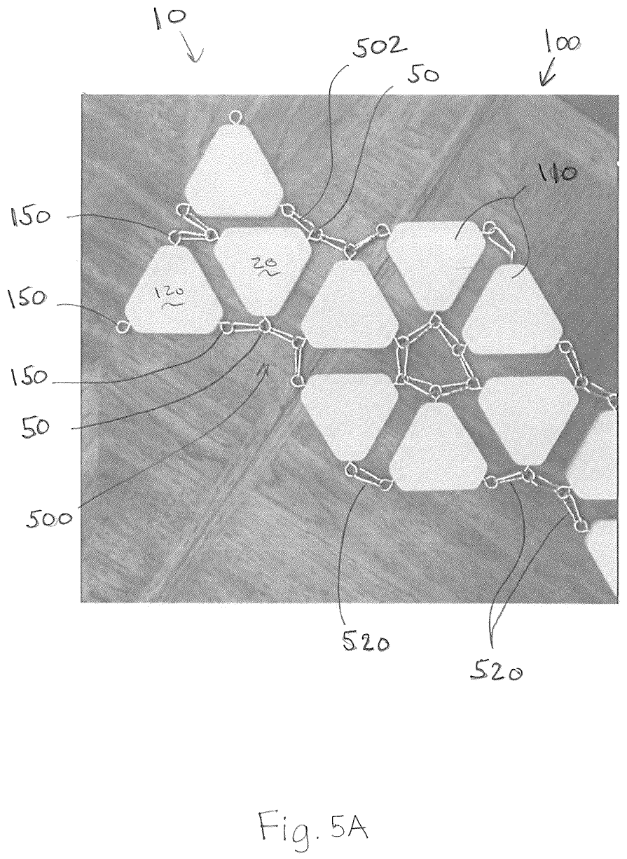

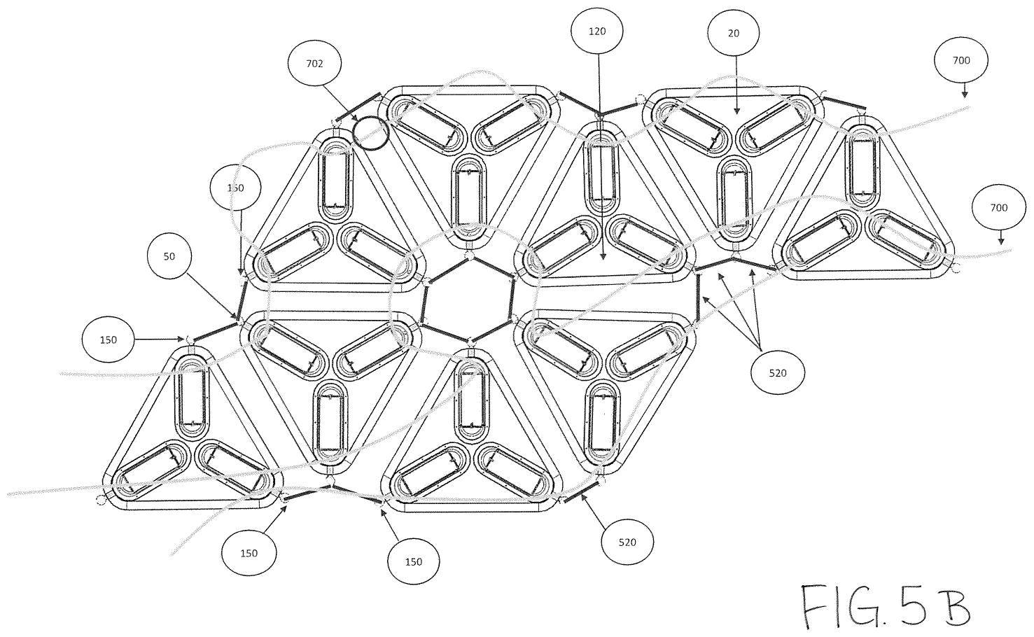

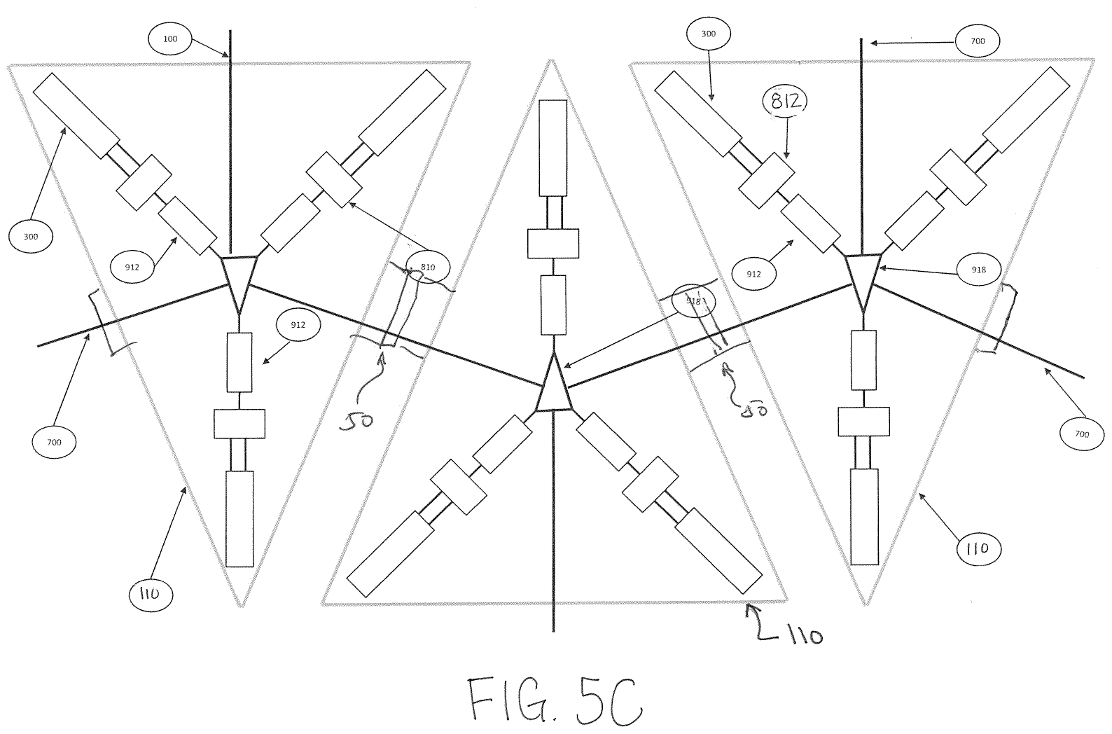

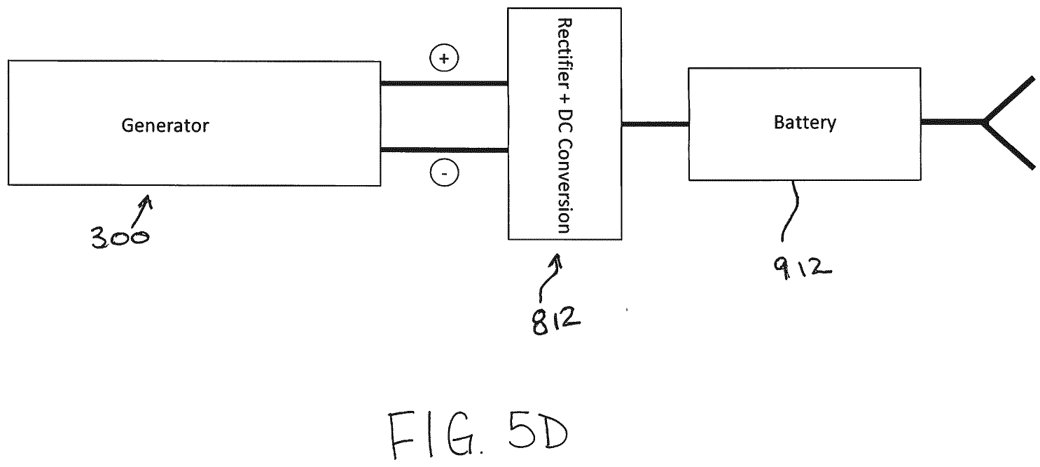

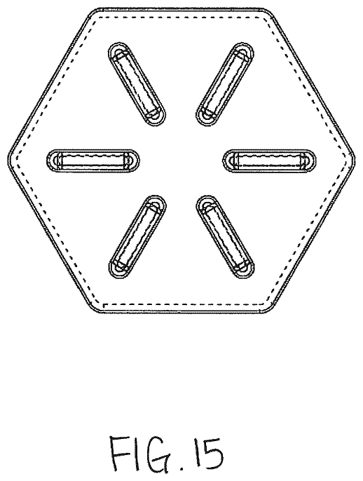

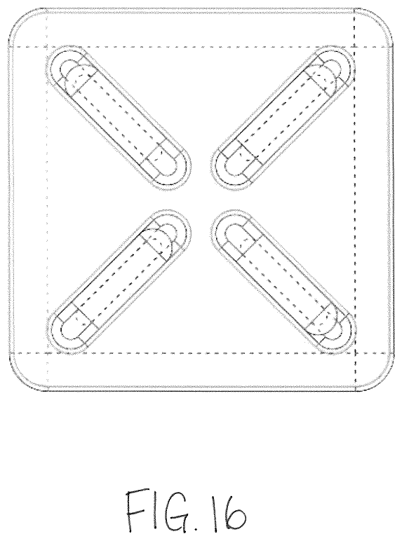

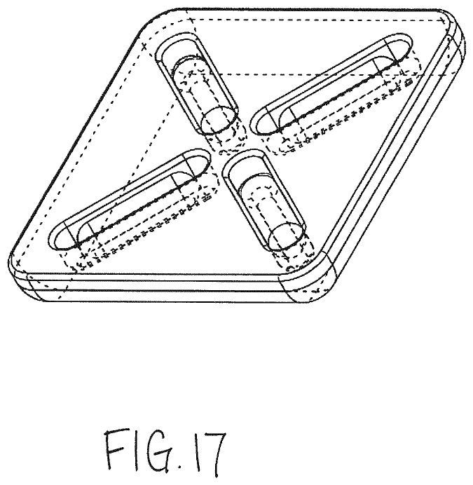

Referring now to FIGS. 1-3, shown is first buoyant panel, designated generally 20. First buoyant panel 20 has a first side 22, a second side 24, and at least three perimeter sides 26. Perimeter sides 26 have a height that defines a width 30 (FIG. 3) of first buoyant panel 20. In a preferred embodiment, at least three perimeter sides 26 forming a shape approximating a triangle. First buoyant panel 20 having a shape approximating a triangle defines three corner regions 32. In one embodiment, corner regions 32 each define a corner. In one embodiment, corner regions 32 define a soft corner 36. In one embodiment, soft corner 36 includes a flat surface. In one embodiment (e.g., FIGS. 1-3, 5B) soft corner 36 includes a rounded surface 40. Other shapes for first buoyant panel 20 are contemplated, including square shapes having four sides 26 with corner regions 32, which may be soft corners 36 with a flat surface (e.g., FIG. 5A) Round shapes (e.g., FIG. 14), pentagon shapes, hexagon shapes (e.g., FIG. 15), octagon shapes, square shapes (e.g., FIGS. 16, 17), etc., are also contemplated.

First panel connector 50 extends from first buoyant panel 20. In one embodiment, first panel connector 50 extends from each corner region 32 of the first buoyant panel 20, see e.g., FIGS. 1-3, 5A, 5B. In another embodiment, first panel connector 50 may extend from side 26 (see, e.g., FIG. 5C) of first buoyant panel 20, such as from a mid point of side 26.

Referring now to FIGS. 5A, 5B, shown is wave powered generator 10 having an array 100 of panels designated generally 110. Panels 110 include first buoyant panel 20 and also include a second buoyant panel 120.

All of panels 110, including second buoyant panel 120, are preferably constructed similarly to first buoyant panel 20 and preferably share the same features and elements as discussed with respect to first buoyant panel 20. For purposes of clarity, similar elements will retain first panel numbering.

Second buoyant panel 120 has second panel connectors 150 that are similar to first panel connectors 50. However, the connectors extending from second buoyant panel 120 will be referred to as second panel connectors 150. In one embodiment, second panel connectors 150 extend from one of corner regions 32 of the second buoyant panel 120. As will be discussed below, first panel connectors 250 and second panel connectors 150 may be movably connected by movable connection 500, such as rigid link 502 (FIG. 5A), e.g., a carabiner or other rigid member. In another embodiment, movable connection 500 may be a flexible link 504 (FIG. 5B), e.g., a cord, a cable, a chain, or other flexible member.

At least one of panels 110, e.g., first buoyant panel 20 or second buoyant panel 120, define at least one cavity 200. In one embodiment, panels 110 define three cavities 200. Cavities 200 are preferably elongated in shape and oriented with a first end 202 proximate to one of corner regions 32. Elongate cavity 202 extends toward a center of a panel, e.g., panel 20, 120, such that a longitudinal axis of cavity 200 is normal to a side of triangular panel 110 opposite to corner region 32.

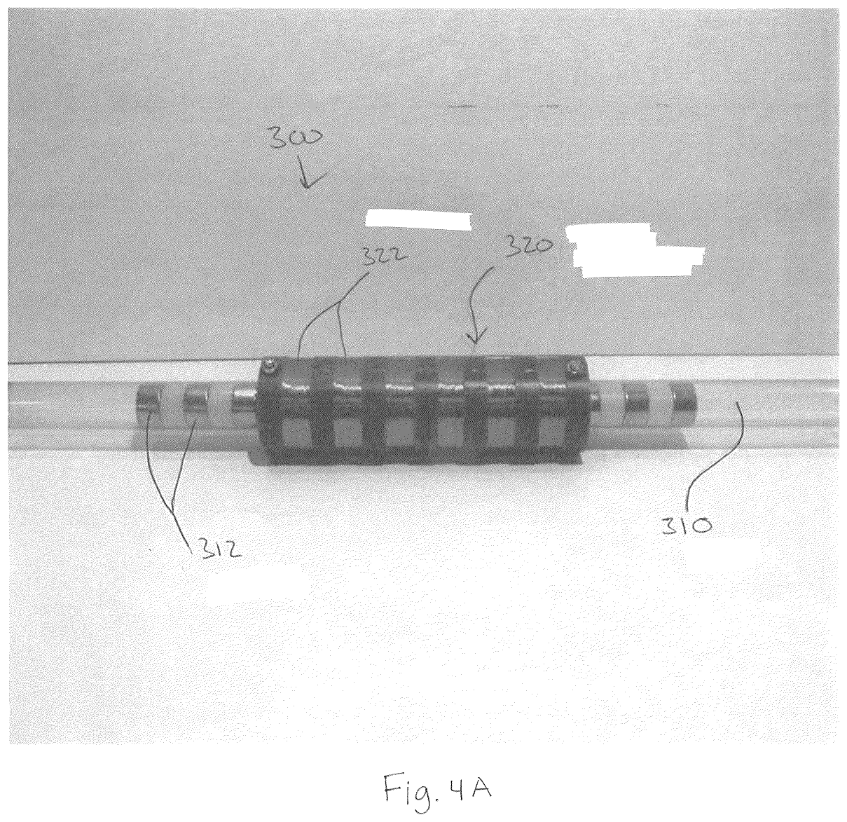

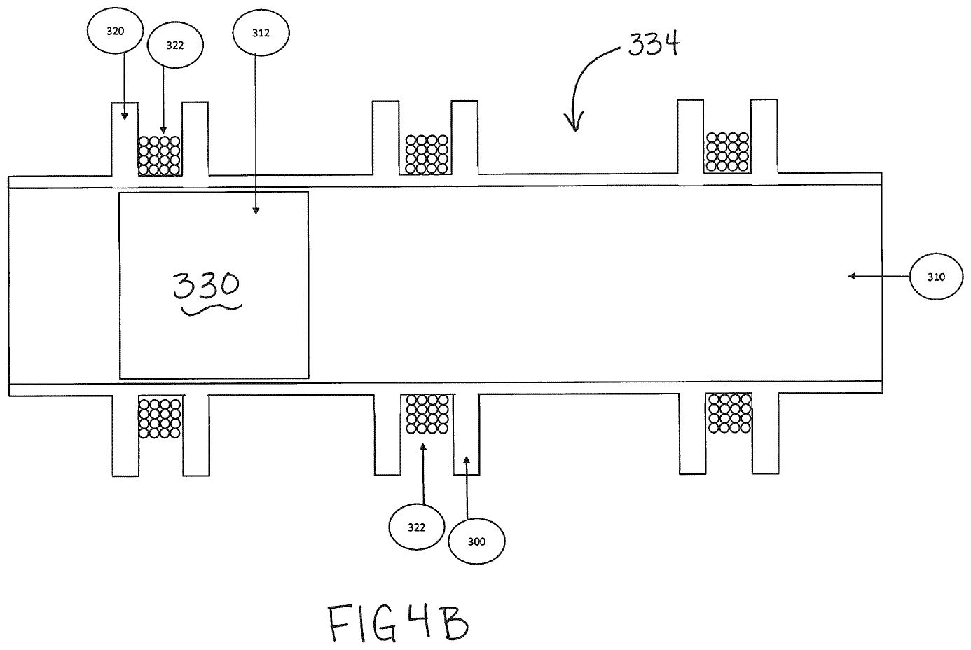

Referring now to FIGS. 4A and 4B, an electrical generator, designated generally 300, is received in cavity 200. In one embodiment (e.g., shown in FIG. 4A), electrical generator 300 is comprised of rod 310 having a plurality of spaced magnets 312. In one embodiment, magnets 312 are spaced apart an equal distance to a width of magnets 312. Rod 310 slidably carries a traveling cylinder 320. Traveling cylinder 320 has conductive windings 322. Sliding movement of traveling cylinder 320 along rod 310, e.g., as a result of tilting of buoyant panel 20, facilitates interaction between conductive windings 322 and a magnetic field generated by the plurality of spaced magnets 312 on rod 310 for generating electricity.

In another embodiment (e.g., shown in FIG. 4B), electrical generator 300 includes traveling slider 330 that carries a plurality of spaced magnets 312 or a single magnet 312. Traveling slider 330 is for traveling within stationary cylinder 334 that is surrounded by conductive windings 322. Sliding movement of traveling slider 330 within stationary cylinder 334, e.g., as a result of tilting buoyant panel 20, facilitates interaction between conductive windings 322 and a magnetic field generated by single or plurality of magnets 312 in traveling slider 330 for generating electricity.

Panels 110 are preferably provided with at least one cover 400 (FIG. 3) for securing electric generator 300 within cavity 200 and for keeping water from entering cavity 200. In one embodiment, three separate covers 402 are provided (FIG. 3), i.e., one for each of cavities 200. In another embodiment, single cover 400 covers multiple cavities 200.

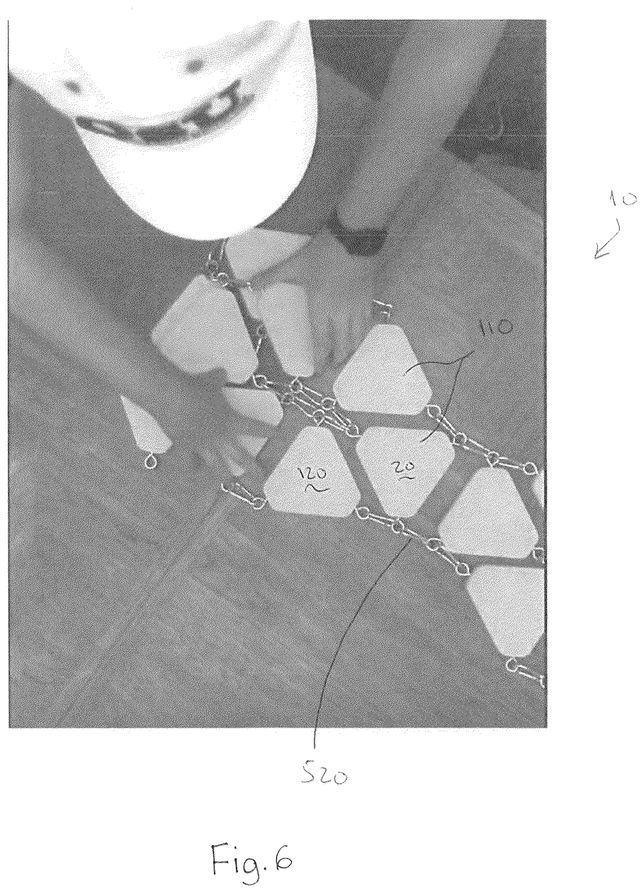

First panel connector 50 and second panel connector 150 are for facilitating movable connection 500 between adjacent panels 110 of array 100, e.g., between first buoyant panel 20 and second buoyant panel 120. In one embodiment, movable connection 500 facilitates relative movement of adjacent panels 110, e.g., first buoyant panel 20 and second buoyant panel 120, in two dimensions, such as may be found in hinged connection 510 (FIG. 5C). In another embodiment, movable connection 500 facilitates movement of adjacent panels in three dimensions, such as might be found in movable connection 500 formed by panel connectors 50, 150 and/or links 520 (see, e.g., FIG. 6), such as rigid link 502 or flexible link 504. As discussed above, flexible link 504 may be a cord that passes through panel connectors 50, 150 to form a movable connection (FIG. 6B).

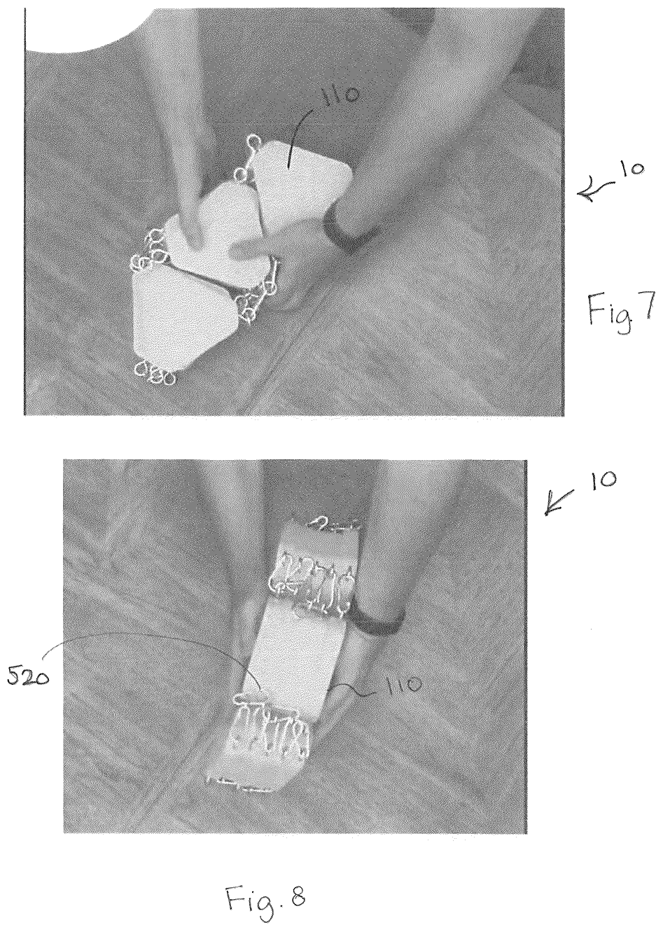

Movable connection 500 is a connection between first panel connector 50 and second panel connector 150. In one embodiment, movable connection 500 further includes at least one panel link 520 between first panel connector 50 and second panel connector 150. In one embodiment, panel link 520 is a single link 520. In another embodiment, panel link 520 is comprised of multiple links. In one embodiment, panel link 520 is at least as long as width 30 of first buoyant panel 20 to facilitate sufficient movement of first buoyant panel 20 and second buoyant panel 120 such that stacking of panels 110 is made possible, as can be seen in FIGS. 6-8.

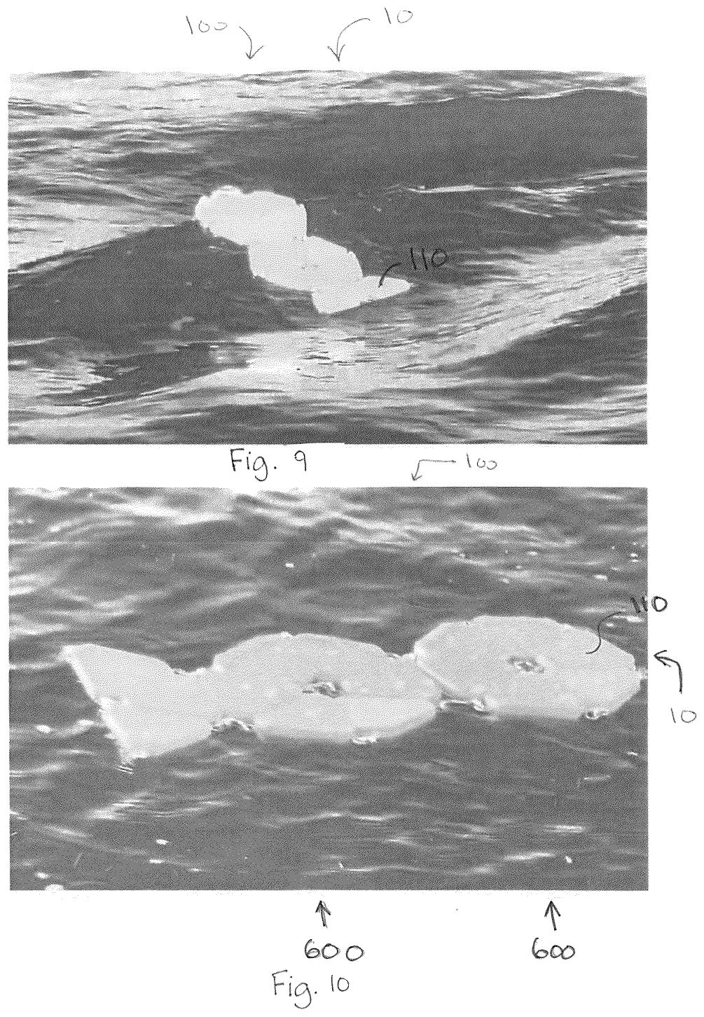

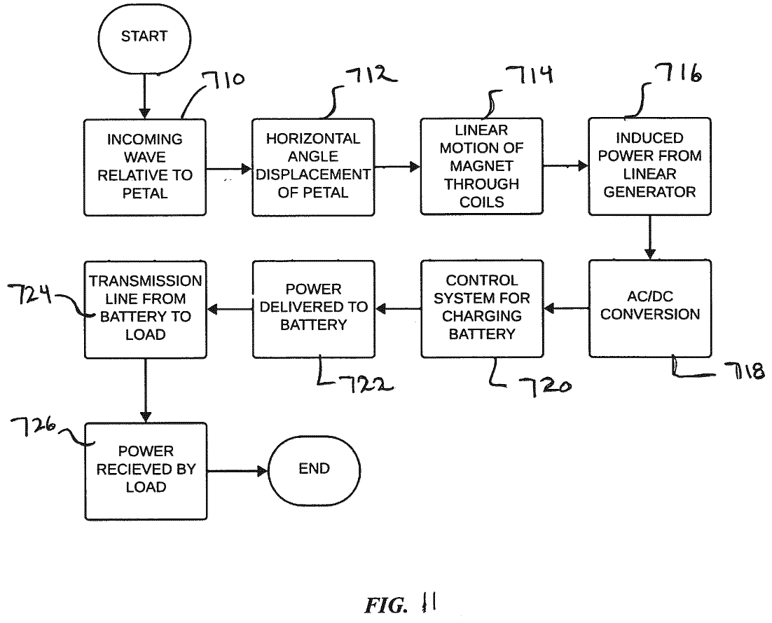

Referring now to FIGS. 5A, 5C, and 6-10, multiple panels 110 are shown interconnected with other panels 110 to form a sheet or array of panels 100.

In an embodiment where panels are triangular in shape, array of panels 100 form at least one unit having a shape approximating a hexagon 600 (e.g. as visible in FIGS. 5A, 5B). In one embodiment, panel connectors 50, 150 of six adjacent panels 100 are located in close proximity to one another wherein each of the panel connectors 50, 150 are connected to panel connectors of adjacent panels, either directly or via panel links 520 as can best be seen in FIG. 6.

Referring to FIG. 15, shown is a sheet or array of panels 100 that are interconnected with wires 700 such that the plurality of electrical generators 300 are connected in series.

It can be seen in FIG. 15 that each wire 700 communicates either with a single electrical generator 300 in a first panel 110 and/or communicates with two electrical generators 300 in an adjacent one of panels 110. In one embodiment, wire 700 is 20 gage magnet wire. In one embodiment, wires that communicate adjacent panels 110 are divided by plug connectors 702 that facilitate removable connection between adjacent panels 110.

One advantage associated with triangular shaped panels 110 is that the resulting array 110 is tightly spaced, thereby promoting a high density of panels 110 as compared to the overall size or array 110. Further, tight packing minimizes lengths of wires 700 required to connect generators 300. Tight packing minimizes water surface coverage, which could be an issue when deploying array 100 adjacent a city or harbor. Utilizing tightly packed array 100 can result in open or unoccupied areas within array 100 of 0% to 20%, 3% to 18%, 5% to 15%, 8% to 12%, or approximately 10% of the total area covered by array 100. In a preferred embodiment, spacing between adjacent panels is between 1 to 3 times, 1.5 to 2.5 times, or 1.7 to 2.5 times thickness 30 of panels 110 to facilitate tight packing and to facilitate the folding of array 100 for storage.

In use, array 100 may be used to power cities and coastal communities. Additionally, array 100 of the invention may be used to provide power to ships and to power offshore platforms such as oil rigs, or may be mounted to structures of an offshore wind farm.

In an example embodiment, a line normal to a first side 26 and extending to an opposite corner has a dimension of 12″. An example thickness or width 30 of panels 110 is 2″.

In a preferred embodiment, electric generators 300 are placed at a midline of width 30 of panels 110 to facilitate ease of handling and folding for storage as shown in FIGS. 6-8.

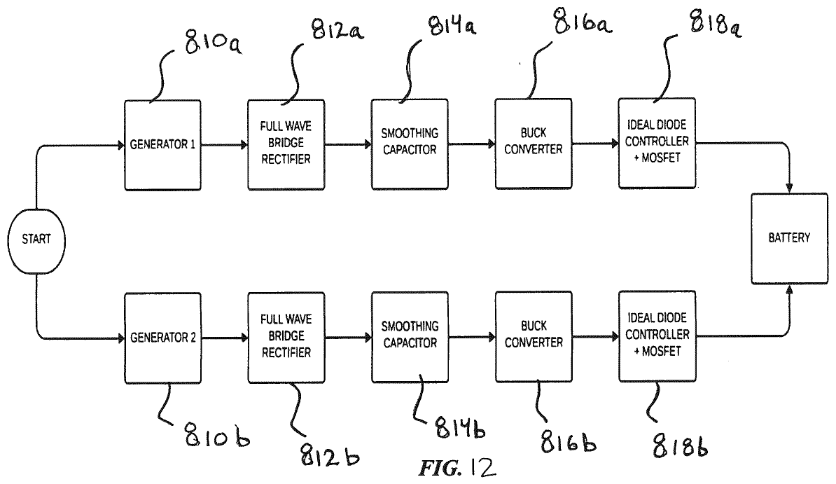

Referring now to FIG. 11, shown is a power flow diagram that depicts steps for wave power generator 10 during a power cycle. Block 710 represents an instance of a given wave approaching a singular panel 110. Once a wave interacts with panel 110, a displacement of panel 110 from horizontal takes place as indicated in block 712, as the surface-floating panel 110 is tilted from horizontal by the oncoming wave. As panel 110 is tilted by the wave, traveling cylinder 320 or traveling slider 330 will travel down a path as indicated in block 714, e.g., traveling cylinder 320 will travel over rod 310 or traveling slider 330 will pass through cylinder 334 and will pass coiled copper wire 322. Through the electromagnetic interaction of magnets 312 with a changing magnetic field relative to coiled copper wire 322, i.e., conductors, an electromotive force is induced within copper coils 322 as indicated in block 716.

To effectively charge a battery, the power output of electrical generator 300 must first undergo an alternating current (AC) to direct current (DC) conversion as indicated in block 718.

Next, the DC power must travel through a control system, as indicated by block 720, to combine outputs for each of, e.g., three generators 300, and to safely charge the battery as indicated by block 722. The control system may operate differently depending on the characteristics of the battery as is known in the art. Finally, the battery charged with the wave powered generator 10 of the invention will supply power to a load of the consumer, as indicated in block 724, via a transmission line, where power is received by a consumer as indicated by block 726. The, “end” block represents the completion of one cycle of this process. This cycle will ideally repeat twice for a given oncoming wave, as panel 110 will be tilted by the both the front and back sides of the wave.

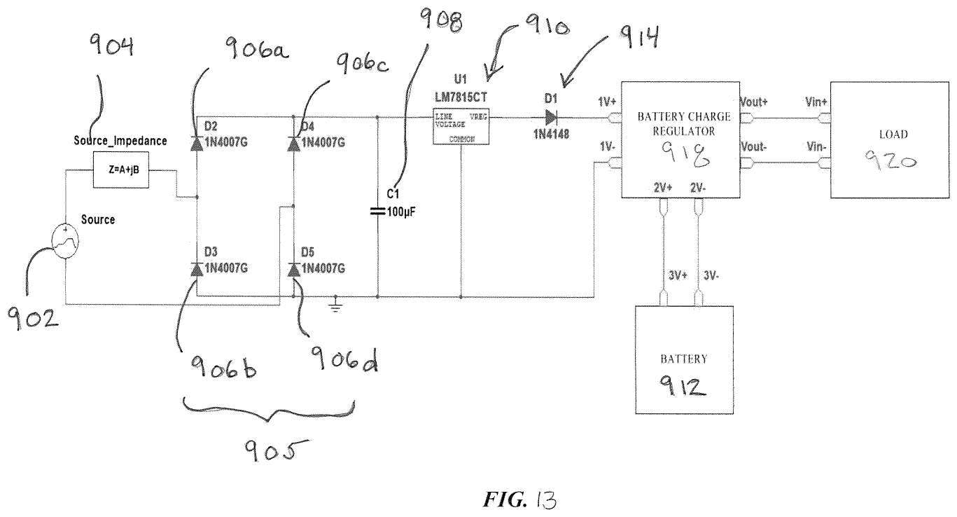

Referring now to FIG. 12, shown is a basic control system (referred to in blocks 718 and 720 of FIG. 11) for safely delivering the power produced from two linear generators 300 to a battery. The “start” block represents an instance from which power is generated (as referenced in block 716 of FIG. 11) from a singular Panel 110 containing two linear generators 300 (represented as “GENERATOR 1” and “GENERATOR 2” in boxes 810a and 810b in the block diagram). As previously mentioned, the power outputs from each linear generator 300 must first individually undergo an AC/DC conversion (see, e.g., block 718 of FIG. 11). The AC/DC conversion can be obtained by means of full wave bridge rectifier 812a, 812b, which generally consists of four diodes to change negative pulse cycles of sinusoidal output of generators 810a and 810b to positive pulse cycles. Next, the waveform travels through smoothing capacitor 814a, 814b to effectively “flatten” the full wave bridge rectifier output to a stable DC voltage level. Next, buck converter 816a, 816b is used to step down the output voltage of generators 810a, 810b to a suitable level for efficient charging of the battery in use. Finally, the signal passes through an N-Channel MOSFET 818a, 818b combined with an ideal diode controller to ensure that the battery is safely being charged, as well as preventing current from travelling back into the circuit components within the control system from the battery. The outputs from generators 810a, 810b are combined and supplied to the battery in a parallel connection. The specific parts for each individual component will vary depending on the output range of each generator 810a, 810b and the battery being used.

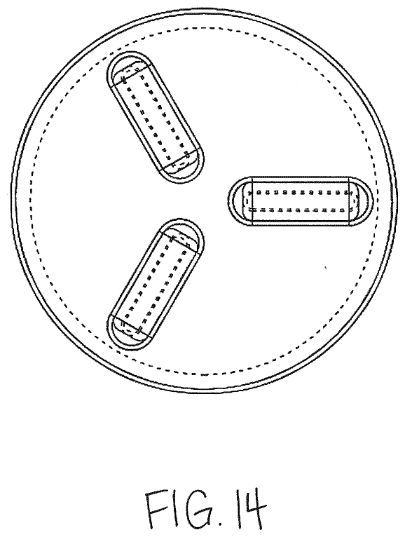

FIG. 13 represents an example of a basic control system (referred to in block 720 of FIG. 11) for safely delivering the power produced from linear generator 300 to a given battery 912, e.g., a lead acid battery. Source 902 represents the induced AC voltage delivered from linear generator 300. “Source_Impedance” 904 represents the impedance from generator 300 itself. Impedance will be directly dependent on the specific wire configuration of copper coils 322, such as the wire gauge and number of turns, within linear generator 300. Following these components, the signal travels through FWBR (full wave bridge rectifier) 905, consisting of four 1N4007G diodes (906a, 906b, 906c, 906d), which will effectively convert all negative cycles of the signal to positive values. Capacitor 908 is placed in parallel from the output of FWBR 905 for smoothing out the signal to approach a DC voltage value. The capacitance value and voltage rating of capacitor 908 is chosen based on the voltage/current levels of the output of generator 300. Following capacitor 908, the positive voltage is connected to a “LINE VOLTAGE” input of linear regulator 910, and negative (GND) voltage is connected to a “COMMON” input of linear regulator 910. “LM7815CT” indicates that linear regulator 910 is a 15V linear regulator. This component value may vary depending on the voltage value of the battery 912, e.g., of a lead acid battery that is in use. Next, a positive output of linear regulator 910 is connected to switching diode 914 to ensure that current does not flow back into generator 300 while charging battery 912. Switching diode 914 is labeled as “D1 1N4148”, but the specific value of switch diode 914 will vary depending on the specifications of generator 300 that is in use. After the signal has travelled through switching diode 914, the output of switching diode 914 is connected to positive terminal (1V+) of battery charging regulator 918, and the output of the “Common” gate of linear regulator 910 is connected to negative terminal (1V−) of battery charging regulator 918. Following this connection, positive terminal (3V+) of a battery 912, e.g., a lead acid battery, is connected to the positive “Battery” terminal (2V+) of the battery charger regulator 918, while negative terminal (3V−) of battery 912 is connected to negative “Battery” terminal (2V−) of battery charge regulator 918. The final connection to be made is from battery charge regulator 918 to a user specified load 920 to be provided to load power. Power delivery will be achieved by connecting “Vout+” and “Vout−” terminals of battery charge regulator 918 to corresponding terminals of load 920 (represented as “Vin+” and “Vin−”) through means of a transmission line. This circuit can be applied to each of linear generators 300 contained within a Panel 110.

It will be appreciated that a system operating in accordance with the above description can readily be adapted by one of skill in the art to utilize other battery chemistries (e.g.,. lithium, nickel-cadmium, nickel-metal hydride, etc.).

Although particular embodiments have been described herein, it will be appreciated that the invention is not limited thereto and that many modifications and additions thereto may be made within the scope of the invention. For example, various combinations of the features of the following dependent claims can be made with the features of the independent claims without departing from the scope of the present invention.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A wave driven electrical generator comprising:
a first buoyant panel having a first side, a second side and at least three perimeter sides, said perimeter sides having a height that defines a width of said first buoyant panel;
a second buoyant panel having a first side, a second side and at least three perimeter sides, said perimeter sides having a height that defines a width of said second buoyant panel;
a movable connection between said first buoyant panel and said second buoyant panel;
a generator mounted on at least one of said first buoyant panel and said second buoyant panel.

2. The wave driven electrical generator of claim 1 further comprising:
wherein said at least three perimeter sides of said first buoyant panel is three perimeter sides for forming a shape approximating a triangle.

3. The wave driven electrical generator of claim 1 wherein:
said first buoyant panel defines at least one cavity, said cavity for receiving said generator.

4. The wave driven electrical generator of claim 3 wherein:
said at least three perimeter sides of said first buoyant panel is three perimeter sides forming a shape approximating a triangle, said shape defining corner regions;
said at least one cavity is three cavities;
said three cavities each being elongate in shape and oriented with a first end proximate one of said corner regions and extending towards a center of said first buoyant panel such that a longitudinal axis of said cavity is normal to a side of said triangle shape opposite said corner region.

5. The wave driven electrical generator of claim 3 comprising:
at least one cover for protecting said electrical generator within said cavity.

6. The wave driven electrical generator of claim 5 wherein:
said at least one cover is three covers; and
said at least one cavity is three cavities.

7. The wave driven electrical generator of claim 1 wherein:
said perimeter sides defining corner regions;
said movable connection comprises a first panel connector extending from one of said corner regions of said first buoyant panel.

8. The wave driven electrical generator of claim 1 wherein:
said movable connection facilitates relative movement of adjacent panels in two dimensions.

9. The wave driven electrical generator of claim 1 wherein:
said movable connection facilitates movement of said adjacent panels in three dimensions.

10. The wave driven electrical generator of claim 1 further comprising:
a first panel connector extending from said first buoyant panel;
a second panel connector extending from said second buoyant panel;
said first panel connector and said second panel connector comprising said moveable connection between said first buoyant panel and said second buoyant panel.

11. The wave driven electrical generator of claim 10 wherein:
said movable connection is further comprised of at least one panel link between said first panel connector and said second panel connector, wherein said at least one panel link is a single link.

12. The wave driven electrical generator of claim 11 wherein:
said at least one panel link is comprised of multiple links.

13. The wave driven electrical generator of claim 11 wherein:
said at least one panel link is a rigid link.

14. The wave driven electrical generator of claim 11 wherein:
said at least one panel link is a flexible link.

15. The wave driven electrical generator of claim 11 wherein:
said at least one panel link has a length that is at least as long as said width of said first buoyant panel to facilitate stacking of said first buoyant panel and said second buoyant panel.

16. The wave driven electrical generator of claim 1 wherein:
said generator has a rod having a plurality of spaced magnets, said rod slidably carrying a traveling cylinder, said travelling cylinder having conductive windings;
wherein sliding movement of said travelling cylinder along said rod facilitates interaction between said conductive windings and a magnetic field generated by said plurality of spaced magnets of said rod.

17. The wave driven electrical generator of claim 1 wherein:
said generator is comprised of a traveling slider carrying a magnet;
wherein said travelling slider for travelling within a stationary cylinder surrounded by conductive windings, wherein sliding movement of said travelling slider within said stationary cylinder facilitates interaction between said conductive windings and a magnetic field generated by said magnet in said travelling slider.

18. The wave driven electrical generator of claim 1 further comprising:
at least one additional panel connected with said first buoyant panel and said second buoyant panel to form an array of panels.

19. The wave driven electrical generator of claim 18 comprising:
wherein panel connectors of six adjacent panels are located in close proximity to one another and wherein each of said panel connectors is connected to panel connectors of two adjacent panels.

20. The wave driven electrical generator of claim 18 wherein:
said array of panels provides an area of coverage, said area of coverage comprising open areas within said array of panels, said open areas define less than 20% of said area of coverage.

21. The wave driven electrical generator of claim 20 wherein:
said open areas define 5% to 15% of said area of coverage.

22. The wave driven electrical generator of claim 21 wherein:
said open areas define approximately 10% of said area of coverage.

23. A buoyant panel for a wave driven electrical generator comprising:
a body having a first side, a second side and at least three perimeter sides, said perimeter sides having a height that defines a width of said body;
a generator mounted on said body for activation by tilting of said body.

24. The wave driven electrical generator of claim 23 wherein:
said body defines at least one cavity, said cavity for receiving said generator.

25. The wave driven electrical generator of claim 23 wherein:
said at least three perimeter sides of said body is three perimeter sides forming a shape approximating a triangle, said shape defining corner regions;
said at least one cavity is three cavities;
said three cavities each being elongate in shape and oriented with a first end proximate one of said corner regions and extending towards a center of said body such that a longitudinal axis of said cavity is normal to a side of said triangle shape opposite said corner region.

26. The wave driven electrical generator of claim 23 wherein:
said generator has a rod having a plurality of spaced magnets, said rod slidably carrying a traveling cylinder, said travelling cylinder having conductive windings;
wherein sliding movement of said travelling cylinder along said rod facilitates interaction between said conductive windings and a magnetic field generated by said plurality of spaced magnets of said rod.

27. The wave driven electrical generator of claim 23 wherein:
said generator is comprised of a traveling slider carrying a magnet;
wherein said travelling slider for travelling within a stationary cylinder surrounded by conductive windings, wherein sliding movement of said travelling slider within said stationary cylinder facilitates interaction between said conductive windings and a magnetic field generated by said magnet in said travelling slider.
